(19) United States
(12) Patent Application Publication
(10) Pub. No.: US 2006/0113810 A1
(43) Pub. Date: Jun. 1, 2006

(54) Modular overhead console assembly for a vehicle

(75) Inventors: Richard D. Kuhl, Troy, MI (US); Edward R. Adams, Englewood, TN (US); Martin R. Kern, Reutlingen (DE); George Vidican, Rochester Hills, MI (US); Michael Lawrence, Troy, MI (US)

Correspondence Address: REISING, ETHINGTON, BARNES, KISSELLE, P.C., P O BOX 4390, TROY, MI, 48099-4390, US

(73) Assignee: Sidler Inc., Madison Heights, MI (US)

(21) Appl. No.: 10/999,436

(22) Filed: Nov. 30, 2004

(51) Int. Cl. B60R 7/04

(52) U.S. Cl. 296/24.34

(57) ABSTRACT

A modular overhead console assembly adapted to be mounted to a roof of a vehicle within a passenger compartment of the vehicle. The modular overhead console assembly includes a rail that has a rail base and a rail head extending from the rail base, wherein a track is defined between the rail head and the rail base. The modular overhead console assembly further includes a movable module that slidably mounts to the rail along at least a portion of the length thereof. The movable module includes a base having a portion thereof extending into the track.

### TECHNICAL FIELD

The present invention relates generally to vehicle consoles and more particularly to a modular overhead console assembly for a vehicle.

### BACKGROUND

Overhead consoles, or like accessories, have been used in passenger compartments of vehicles for many years, including overhead lights, storage compartments, trip computers, vents, and the like. According to conventional designs, overhead accessories are usually stand-alone units or assemblies that are individually affixed to a roof of the vehicle. Unfortunately, conventional designs often require a vehicle manufacturer to individually install a multitude of different accessory units in various locations to a roof of a vehicle. Moreover, the conventional designs do not enable vehicle dealers to easily install optional overhead accessory units on a vehicle at a dealership to customize the vehicle for a particular customer. Also, the conventional designs often necessitate individually connecting the various accessories with multitudes of different wiring harnesses that must be extended through a headliner in various locations of the vehicle.

More recently, overhead console assemblies have been proposed to provide modular accessories, and to provide electrical connections to supply power to the accessories. Unfortunately, however, these recent approaches have several disadvantages. For example, some modular overhead console assemblies do not provide a simple failsafe means to lock accessory modules in place so as to effectively and inexpensively comply with vehicle impact requirements. Although other modular overhead console assemblies provide electrical power to movable modules, such assemblies involve electrifying the rails to which the modules are movably attached, and this may involve relatively expensive anodized aluminum masking or plastic metallization techniques. Moreover, existing modular overhead console assemblies also tend to be bulky and thereby unduly restrict headroom in a vehicle passenger compartment. Also, present modular overhead console assemblies include modules that wrap around and connect to outboard sides of the rails to which the modules are mounted, thereby exposing unsightly rail tracks or visible wear patterns on the rails. Finally, current modular overhead console assemblies generally involve an excessive quantity of components and are otherwise unnecessarily complex in design and manufacture.

Accordingly, it can be appreciated that modular overhead console assemblies are not fully developed for optimal performance and simplicity in design and, thus, are too costly to be implemented in vehicles of all market segments.

### BRIEF SUMMARY

A modular overhead console assembly in accordance with one aspect of the invention is adapted to be mounted to a roof of a vehicle within a passenger compartment of the vehicle. The modular overhead console assembly includes a rail that includes a rail base and a rail head extending from the rail base, wherein a track is defined between the rail head and the rail base. The modular overhead console assembly further includes a movable module that slidably mounts to the rail along at least a portion of the length thereof. The movable module includes a base having a portion thereof extending into the track.

### BRIEF DESCRIPTION OF THE DRAWINGS

Features and advantages of the present invention will be apparent to those of ordinary skill in the art from the following detailed description of preferred exemplary embodiments and best mode of the invention and the claims, with reference to the accompanying drawings in which:

FIG. 1 is a perspective view of a modular overhead console assembly according to an exemplary embodiment of the present invention;

FIG. 2 is a partially exploded, fragmentary, perspective view of the modular overhead console assembly of FIG. 1;

FIG. 3 is an enlarged, fragmentary, cross-sectional view of a portion of the modular overhead console assembly of FIG. 1;

FIG. 4 is an enlarged perspective view of a portion of the modular overhead console assembly of FIG. 1, with a headliner removed;

FIG. 5 is a perspective view of select components of the modular overhead console assembly of FIG. 1;

FIG. 6 is a partial cross-sectional view of a module of the modular overhead console assembly of FIG. 1, illustrating a lever and latch in their default locked positions;

FIG. 7 is a partial cross-sectional view of the module of FIG. 6, illustrating the lever and latch in their selective unlocked positions;

FIG. 8 is a plan view of the modular overhead console assembly of FIG. 1 with the headliner removed and showing electrical connectors.

FIG. 9 is an enlarged, fragmentary, cross-sectional view of a portion of a modular overhead console assembly according to a second exemplary embodiment of the present invention;

FIG. 10 is an enlarged cross-sectional view of a portion of a modular overhead console assembly according to a third exemplary embodiment of the present invention; and

FIG. 11 is an enlarged cross-sectional view of a portion of a modular overhead console assembly according to a fourth exemplary embodiment of the present invention.

### DETAILED DESCRIPTION

In general, the invention will be described in several illustrative embodiments of a modular overhead console assembly for use in a passenger compartment of a vehicle and that includes stationary and movable accessory modules to provide flexible and modular options in vehicle interior lighting, storage, entertainment, comfort, and the like. The invention will be described with reference to its use in automotive vehicles such as cars, trucks, sport-utility vehicles, and the like. However, it will be appreciated as the description proceeds that the invention is useful in many different applications such as recreational vehicles, aircraft, watercraft, and the like, and may be implemented in many other embodiments. In this regard, and as used herein and in the claims, it will be understood that the term “vehicle” refers not only to automotive applications, but also to any other applications wherein the present invention is useful in passenger compartments thereof.

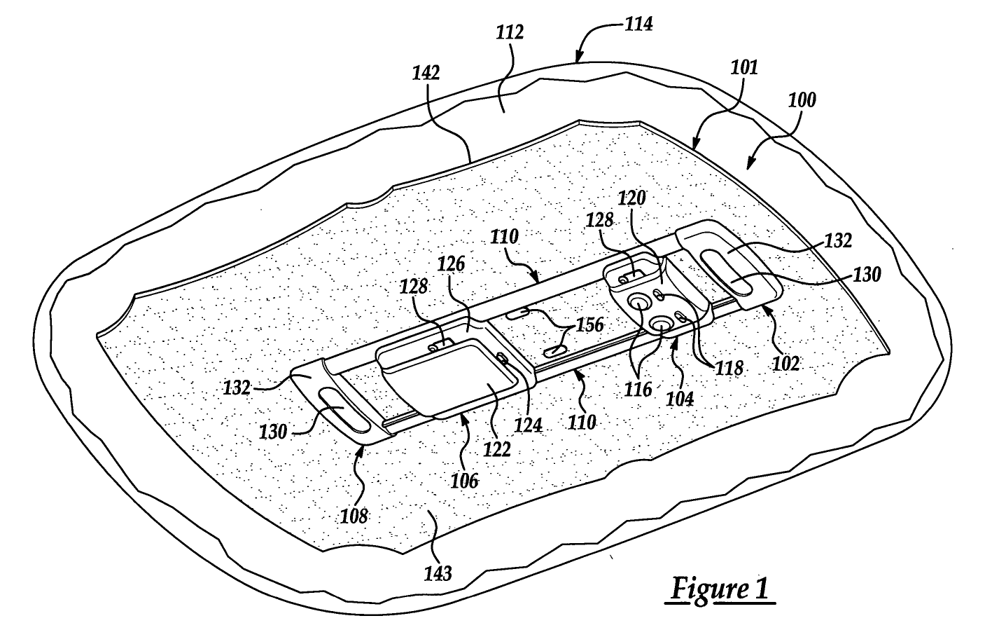

Referring specifically to the drawings, FIGS. 1 through 3 illustrate a modular overhead console assembly 100 according to an exemplary embodiment of the present invention. The assembly 100 represents a simple, effective, and economical solution for providing stationary and movable modules 102-108 that are adjacent a headliner 101 and are easily removable and replaceable by manufacturers, dealers, or consumers, and that lock in place along one or more rails 110 in a fail-safe manner to comply with vehicle impact requirements.

As shown in FIG. 1, the assembly 100 preferably includes the headliner 101 and is adapted for mounting to an inside surface 112 of a roof 114 of a vehicle within a passenger compartment thereof. The assembly preferably extends along substantially an entire length of the roof of the vehicle, but may span a shorter portion thereof. As shown, the assembly 100 includes a movable lighting module 104 and a movable storage module 106. The lighting module 104 includes a pair of bug eye lights 116 and associated push button power switches 118 mounted to a housing 120. The storage module 106 includes a compartment door 122 and associated push button door release switches 124 mounted to a housing 126. Both modules 104, 106 include finger levers 128 shown in default locked positions. A vehicle occupant may pull and rotate the levers 128 to their unlocked position to unlock the modules 104, 106 from the rails 110, whereafter the occupant may slide the modules 104, 106 to any desired position along the rails 110 within the vehicle. As also shown, the stationary modules 102, 108 may be end caps that are positioned at longitudinally opposed ends of the assembly 100 and that include light lenses 130 mounted to housings 132.

Such stationary and movable modules 102-108 may provide various accessories including lighting, storage, entertainment units including video and/or audio equipment, and other like accessories. Occupants of the vehicle can easily adjust the position of the movable modules 104, 106 to suit their needs. In other words, the movable modules 104, 106 are slidable along the longitudinal axis of a vehicle so as to accommodate forward and backward adjustments in seating, enable positioning preferences of occupants, provide head clearance for occupants, make efficient use of accessories within the passenger compartment, and the like. Also, dealers and consumers may customize the look and function of the passenger compartment of the vehicle by removing and replacing the movable and stationary factory-supplied modules with various after-market modules.

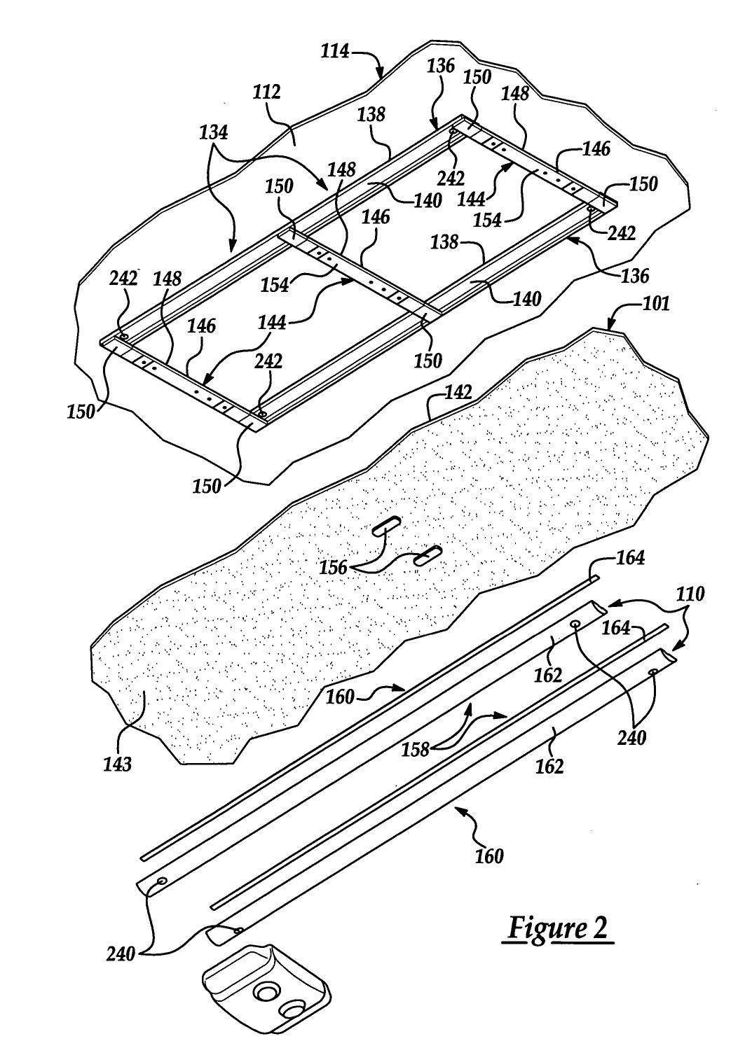

As shown in FIG. 2, a support sub-assembly 134 is adapted to be positioned against the inside surface 112 of the roof 114 of the vehicle and is defined in part by a pair of supports 136 extending longitudinally along the length of the roof 114 of the vehicle. As used herein, the terminology positioned against or mounted against may encompass a component in actual contact with another component or may encompass a component that is faces another component but does not touch. The supports 136 have upper surfaces 138 adapted to be positioned adjacent or facing the inside surface 112 of the roof 114 and also have opposed, lower surfaces 140 adapted to be positioned adjacent or facing an upper surface 142 of the headliner 101. The supports 136 are preferably stamped or otherwise formed rigid metal components. The support sub-assembly 134 is also defined by several transversely extending cross-members 144 positioned between the ends and middle of the pair of supports 136. The cross-members 144 are preferably composed of metal, or glass-filled plastic, but may be composed of any other desired material. The cross-members 144 have mid-sections 146 with upper surfaces 148 adapted to be mounted adjacent or facing the inside surface 112 of the roof 114 and further have longitudinally opposed ends 150 with upper surfaces 152 adapted to be mounted against the lower surfaces 140 of the supports 136. The mid-sections 146 also have opposed, lower surfaces 154 adapted to be positioned against the upper surface 142 of the headliner 101. If desired, the support sub-assembly 134 may be attached to the roof 114 using fasteners (not shown) attaching one or more of the cross-members 144 and/or supports 136 directly to the roof 114. In addition or alternatively, the support sub-assembly 134 may be attached to the roof 114 with adhesive or an integral fastening arrangement, and/or may be held in place against the roof 114 by the headliner 101, which may be attached to the roof 114 in any manner known to those of ordinary skill in the art. Fastener covers 156 may be used to cover fasteners (not shown), which attach the headliner 101 to the roof 114 or the like.

The headliner 101 is preferably adapted to cover substantially the entire inside surface 112 of the roof 114 and may be composed of a flexible, semi-flexible, or rigid, or semi-rigid component or may be an assembly of such different components such as a rigid structural base member with layers of flexible insulation and fabric attached thereto. In any case, except for the modifications necessitated by the invention hereof, the headliner 101 may be a conventional headliner, which is well known to those of ordinary skill in the art.

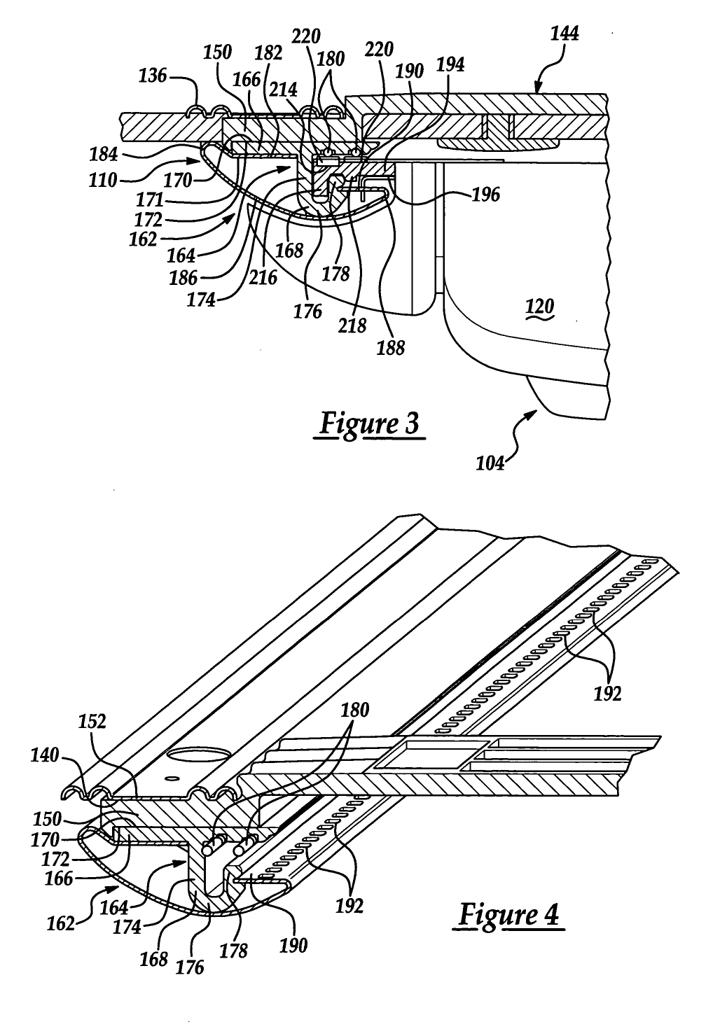

The pair of rail assemblies or rails 110 is positioned against a lower surface 143 of the headliner 101 and is preferably attached to the support sub-assembly 134 through the headliner 101 such as to the cross-members 144, supports 136, or both. Alternatively, it is contemplated that the rails 110 could be mounted directly to the roof 114 itself through the headliner 101 in the case where a support sub-assembly 134 is not desired. The rails 110 extend substantially parallel to, and overlap, the longitudinally extending supports 136, and may be constructed of single components or may be constructed of two or more rail components, as will be described in detail herein below. The rails 110 have inboard sides 158 laterally between the rails 110 and oppositely disposed outboard sides 160. The rails 110 of the present invention are illustrated in accordance with particular cross-sectional shapes, but the rails may be constructed from any suitable cross-sectional shape that achieves the functionality described herein. As better shown in FIG. 3, the rails 110 may be constructed of an individual rail cover 162 that is attached to an individual module rail 164.

The module rail 164 is preferably an extruded component, preferably composed of polyoxymethylene (POM) or acrylonitrile-butadiene-styrene (ABS), but may be composed of any other desired material. The module rail 164 includes a substantially flat and horizontally and longitudinally extending mounting flange or rail base 166 and a longitudinally extending rail head 168 that extends integrally vertically downward from the rail base 166. The rail bases 166 include upper surfaces 170 adapted to mount flat against lower surfaces 172 of the laterally opposed ends 150 of the cross-members 144 and may be attached thereto, to the supports 136, and/or to the roof (not shown) through the supports 136, by fasteners (not shown). As shown, the rail base 166 extends in an inboard direction to cover a transition between the headliner 101 and an inboard edge of the cross-member end 150. The rail head 168 is preferably integral with the rail base 166, is J-shaped, and extends generally vertically away from a lower surface 171 of the rail base 166 including a beam 174, a bend 176, and terminating in a flange 178.

The rail head 168 and the rail base 166 define a track therebetween for accepting portions of the movable module 104 and for guiding the module 104 along the rails 110 as will be described in greater detail below. On a laterally inboard side of the rail head 168, the lower surface 171 of the rail base 166 includes grooves therein for accepting electrical power and/or electrical communication conductors 180, which are preferably integrally snap fit or interference fit therein.

The rail cover 162 is preferably a roll-formed or otherwise metal-formed component preferably composed of steel or aluminum, but may also be composed of any other desired material. For aesthetics, the rail cover 162 may be decorated by painting with powder paint or may be anodized or the like. In a lateral direction, the rail cover 162 originates at an outboard edge and extends in an outboard direction to define an outboard flange 182 and an outboard lip 184, which covers a transition between the headliner 101 and the outboard edge of the cross-member 144, which protrudes through an opening in the headliner 101. The rail cover 162 bends about the outboard lip 184 and extends in an inboard direction defining a curved portion 186 that terminates in an inboard lip 188. The rail cover 162 bends about the inboard lip 188 and extends in an outboard direction, terminating in an inboard edge and defining an inboard flange 190. The inboard edge integrally snap fits within an inboard groove formed in the flange 178 of the rail head 168. The rail cover 162 is dimensioned in such a way that once the inboard edge thereof is snap fit to the flange 178 of the rail head 168, the outboard flange 182 of the rail cover 162 is biased flat against the lower surface 171 of the rail base 166 for a robust and snug fit. As shown in FIG. 4, the inboard flange 190 of the rail cover 162 includes a series of longitudinally spaced apart engagement elements 192, which are preferably perforations formed during the preferred roll-forming process of the rail cover 162, but may be any suitable engagement element including integrally formed projections or separately attached teeth (not shown). The engagement elements 192 of the rail cover 162 are preferably adapted for default interlocking or default engagement with, and selective unlocking or selective disengagement from, portions of the moveable module 104, as will be described in greater detail herein below. Just the movable lighting module 104 is shown, for exemplary purposes, and the foregoing description applies also to the storage module 106.

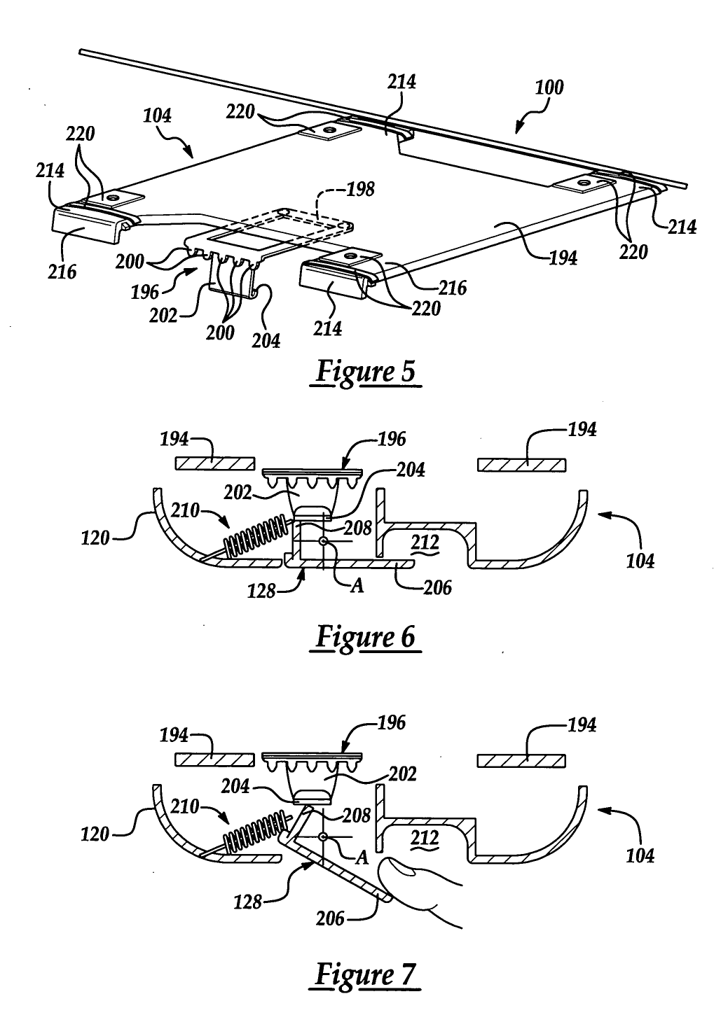

As shown in FIGS. 3 and 5, the moveable module 104 includes a substantially planar base 194, which has a lock or latch 196 attached thereto. The base 194 also provides support for the outer cover or housing (not shown), which may be fastened to the base 194, snap fit to the base 194, or the like, in any desired manner. The base 194 is preferably composed of POM, and the housing is preferably composed of ABS, polycarbonate ABS, thermoplastic olefin, or the like, but any portion of the modules 102-108 may be composed of any other suitable materials. The latch 196 includes a base portion 198 fastened to the base 194 of the module 104, such as by individual fasteners (not shown), an integral plastic spin-formed connection, or the like. Opposite the base portion 198, the latch 196 includes several engagement elements 200 protruding in a downward direction for locking engagement with the spaced apart engagement elements 192 of the rail cover 162 (shown in FIG. 4). As shown, the engagement elements 200 are integrally formed spaced apart teeth-like protrusions, but may instead be spaced apart perforations (not shown) that cooperate with spaced apart projections (not shown) formed on the rail cover. The module 104 is preferably adapted for default interlocking or default engagement with, and selective unlocking or selective disengagement from, the rails 110 to which the module 104 is mounted. To this end, the latch 196 further includes a tang 202 extending in a downward direction and terminating in an upturned lip 204 for engagement with the finger lever 128 of the module 104, as will be described below with reference to FIGS. 6 and 7.

FIGS. 6 and 7 represent schematic cross-sections of the module 104, taken along a longitudinal direction through a portion of the module 104 to illustrate the interaction between the finger lever 128 and latch 196. The finger lever 128 may be a separate component, as shown, which is pivotably mounted to the module housing 120 about an axis A. The finger lever 128 includes an input flange 206 and an output flange 208 extending therefrom. A coiled tension spring 210 is shown schematically and may be attached to an interior portion of the module housing 120 at one end and may be attached to the output flange 208 of the finger lever 128 at an opposite end. A finger recess 212 is provided in the module housing 120 to provide access to a free end of the input flange 206 of the finger lever 128.

As shown in FIG. 6, and as discussed above, the latch 196 is mounted to the base 194 of the module 104 in any desired manner. The latch 196 is mounted in such a way that the lip 204 of the tang 202 just makes initial contact with the free end of the output flange 208 of the finger lever 128. In this position, the engagement elements 200 of the latch 196 engage the engagement elements of the rail (not shown) to prevent the module 104 from sliding along the rails 110.

As shown in FIG. 7, however, a passenger may unlock or unlatch the module 104 by pulling on the finger lever 128 to overcome the retracting bias force of the spring 210, whereby the finger lever 128 is pivoted about its mounting axis A so as to rotationally and vertically displace the output flange 208 of the finger lever 128 into engagement with the tang 202 of the latch 196. This pivoting of the finger lever 128 vertically displaces the tang 202 of the latch 196. Vertical displacement of the latch tang 202 also yields vertical displacement of the engagement elements 200 of the latch 196, thereby yielding disengagement of the engagement elements 200 of the latch 196 from the engagement elements 192 of the rail cover 192 (shown in FIG. 4). Accordingly, the module 104 may be readily slid along the rails 110 until the passenger releases the finger lever 128. Once the finger lever 128 is released, the tension spring 210 pulls on the output flange 208 of the finger lever 128 to pivot the finger lever 128 about axis A back to its default locked position. This permits the latch 196 to return to its default locked position wherein the engagement elements 200 of the latch 196 re-engage the engagement elements 192 of the rail cover 162 (shown in FIG. 4) to prevent the module 104 from sliding along the rails 110. In other words, the finger lever and latch arrangement of the present invention is default locked or engaged, and is selectively unlockable or disengagable. This arrangement is just one example of many structures that could be used to yield a default locked and selectively unlockable module. In any case this arrangement thus provides a fail-safe method of positively locking the modules 104, 106 in place along the rails 110, as a default mode, to comply with vehicle impact requirements.

Referring again to FIGS. 3 and 5, the base 194 of the module 104 extends in laterally opposed outboard directions and terminates in corner flanges 214, which each terminate in downward-turned guide flanges 216. The base 194 of the moveable module 104 is adapted to slidingly mount to the module rails 164, wherein the guide flanges 216 are adapted to slidingly fit into the tracks defined between the rail heads 168 and rail bases 166. Just inboard of the guide flanges 216, guide ridges 218 are provided. Accordingly, the weight of the module 104 is substantially borne by the contact surface area between the guide flanges 216 and guide ridges 218 on the rail heads 168 of the module rails 164. The contact surfaces are preferably chamfered as shown for smooth sliding.

The corner flanges 214 also have electrical contacts 220 for sliding contact with the conductors 180. The electrical contacts 220 include axially extending rectangular strips that are integral with square pads, as shown. Any number of electrical contacts 220 and conductors 180 may be provided as desired and as permitted by spatial or packaging considerations. Those of ordinary skill in the art of interior accessory and lighting technology will recognize that the electrical contacts 220 may be electrically connected to switches and lights of the modules 102-108, to electrical communications devices of the modules 102-108, and the like.

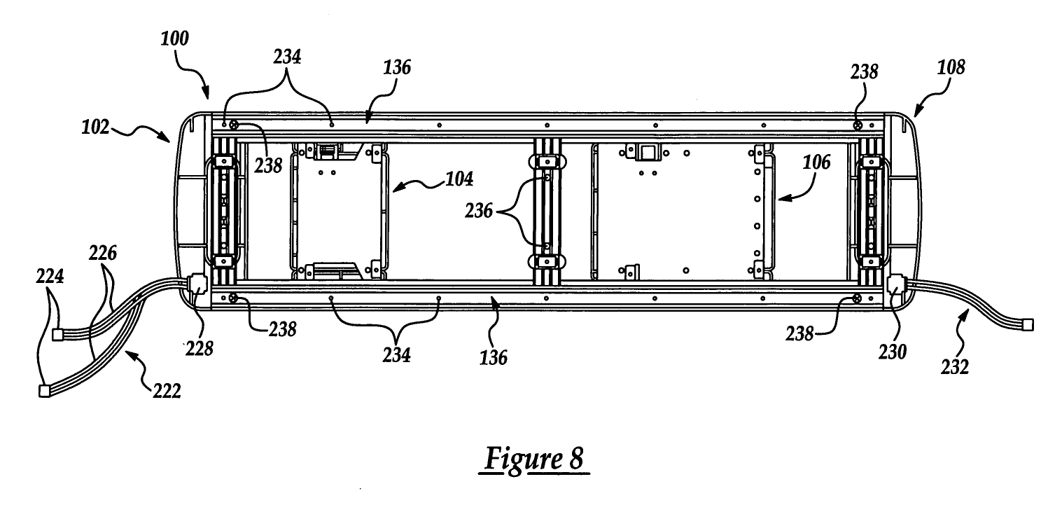

Referring now to FIG. 8, the modular overhead console assembly 100 is shown with the headliner removed. Electrical power and/or communication signals are preferably delivered to the assembly 100 by a front wiring harness 222 having connectors 224, wires 226, and a front assembly connector 228 for electrically connecting the wires 226 to the conductors (not shown) of the assembly 100. Power and/or signals may flow into the front wiring harness 222 from elsewhere within the vehicle such as central power supply, other wiring harnesses, other components or assemblies, and the like (not shown). The power and/or signals may flow from the front wiring harness 222 through the conductors (180 not shown) of the assembly 100 and to the modules 102-108 and/or out of the assembly 100 via a rear assembly connector 230, which is connected to a rear wiring harness 232. The rear wiring harness 232 may be connected elsewhere within the vehicle such as back to the central power supply, other wiring harnesses, other components or assemblies, and the like. This arrangement provides an inexpensive and effective method of providing power to the stationary and movable modules 102-108 without having to separately supply power to each individual module. Rather, this arrangement provides a common electrical supply or bus, wherein the structure of the modular overhead console assembly 100 itself acts as an integrated wiring harness. This eliminates the labor needed to separately attach several different wiring harnesses for several different modules, and permits consumers to easily swap modules in and out of the assembly 100 without having to find, disconnect, and reconnect electrical connectors.

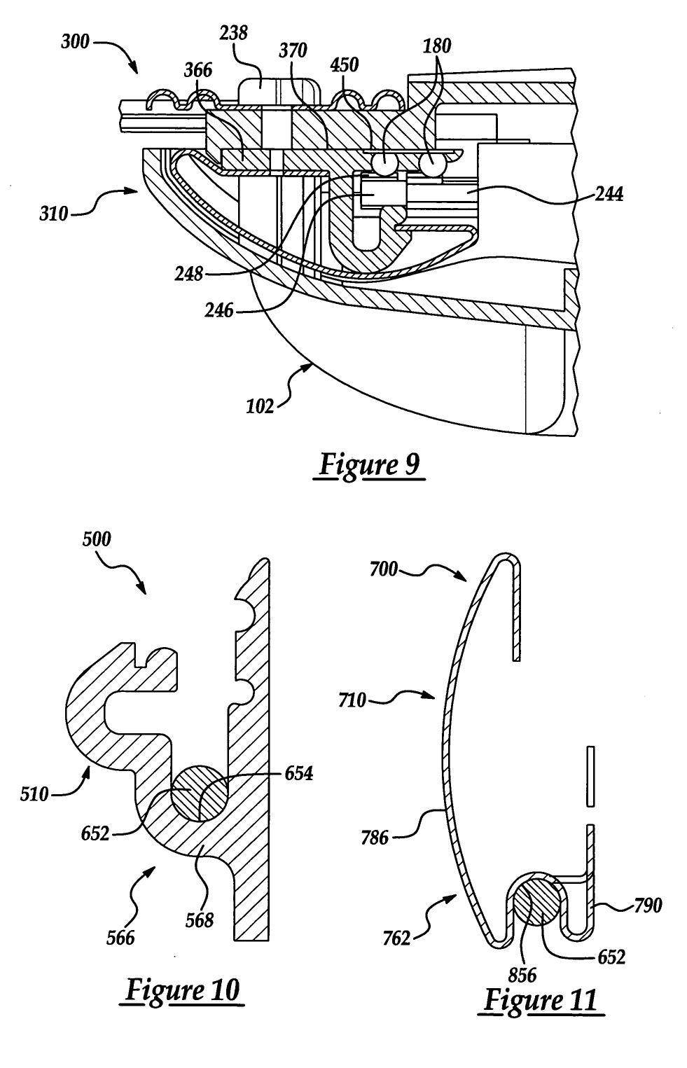

Also shown in FIG. 8 are a plurality of longitudinally spaced apart fastening holes 234 in the supports 136 that may be used to fasten the assembly 100 to the roof (not shown) of the vehicle if desired. Moreover, pairs of laterally spaced apart fastening holes 236 are provided in the cross-members 144 that may be used to fasten the assembly 100 to the roof of the vehicle if desired. Also, fastening or locating posts 238 of the stationary modules 102, 108 are shown protruding through the supports 136, according to one method of attaching the stationary modules 102, 108 to the rest of the assembly 100. This arrangement is also shown in cross-section of the alternative embodiment depicted in FIG. 9.

FIG. 9 illustrates a modular overhead console assembly 300 and rails 310 according to an alternative embodiment of the present invention. The locating posts 238 of the stationary module 102 extend through a rail cover aperture (shown in FIG. 2 as 240) through a module rail aperture (not shown), and through a support rail aperture (shown in FIGS. 2 and 4 as 242). The locating posts 238 preferably fit into such apertures (240, 242) under an interference or snap fit condition to positively retain the stationary modules 102, 108 in place on the assembly 300 to comply with vehicle impact requirements. The stationary modules 102, 108 may be pulled downwardly to overcome the frictional or snap fit of the locating posts 238 in the apertures 240, 242 to remove the modules 102, 108 from the rails 310. Any other type of fastening arrangement of the modules 102, 108 to the rails 310 may also be used. For example, the present invention contemplates adapting the teachings above with respect to the lever and latch configuration of the movable modules 104, 106 to apply a lever and latch configuration to the stationary modules 102, 108. Accordingly, the stationary modules 102, 108 may be adapted to slide axially onto the longitudinally opposed ends of the rails 310 wherein the lever and latch configuration of the stationary modules 102, 108 would thereafter be locked or engaged and lockable or disengagable with respect to the rails 310 as described above. In any event the stationary module 102 has a base portion 244 with corner flanges 246 having electrical contacts 248 in contact with the conductors 180. According to an alternative arrangement, a flexible circuit 450 may be positioned along a module rail 364 and in contact with the conductors 180, for distribution of electrical power and/or communication signals. Alternatively, it is contemplated that the flexible circuit 450 could be adapted for direct contact with the contacts of any of the modules, such as by mounting the flexible circuit 450 to a lower surface 370 of a rail base 366. An exemplary flexible circuit product is available from Sheldahl of Northfield, Minn.

FIGS. 10 and 11 illustrate alternative embodiments of the present invention wherein a cylindrical lighting element 652, such as a light pipe, fiber optic member, or the like, is added to rails 510, 710 of alternative modular overhead console assemblies 500, 700 such as an alternative module rail 566 and/or an alternative rail cover 762. In FIG. 10, a rail head 568 is modified to provide a light pipe channel 654 into which the light pipe 652 is press fit. In FIG. 11, the rail cover 762 is modified to provide a light pipe channel 856 located between an inboard flange 790 and a curved body 786 and into which the light pipe 652 is press fit. The arrangements depicted in FIGS. 10 and 11 provide inboard lighting along the length of the modular overhead console assemblies 500, 700. Accordingly, the entire length, or lengthwise portions, of the passenger compartment of the vehicle may be economically and effectively provided with warm white or colored ambient mood lighting. The light pipe 652 may be connected to a light source in any suitable manner, including using optical harnesses and connectors at the stationary modules similar to the manner in which the electrical conductors are supplied with electrical power and/or signals.

As used in this specification and appended claims, the terms “for example,” “for instance,” and “such as,” and the verbs “comprising,” “having,” “including,” and their other verb forms, when used in conjunction with a listing of one or more components or other items, are each to be construed as open-ended, meaning that that the listing is not to be considered as excluding other, additional components or items. Moreover, directional words such as top, bottom, upper, lower, radial, circumferential, lateral, longitudinal, vertical, horizontal, and the like are employed by way of description and not limitation. Other terms are to be construed using their broadest reasonable meaning unless they are used in a context that requires a different interpretation.

The present invention has been disclosed in conjunction with a limited number of presently preferred exemplary embodiments, but many others are possible and it is not intended herein to mention all of the possible equivalent forms and ramifications of the present invention. Other modifications, variations, forms, or ramifications will readily suggest themselves to persons of ordinary skill in the art in view of the foregoing description, and will fall within the scope of the following claims. In other words, the teachings of the present invention encompass many reasonable substitutions or equivalents of limitations recited in the following claims. For example, the disclosed structure, materials, sizes, shapes, and the like could be readily modified or substituted with other similar structure, materials, sizes, shapes, and the like. In another example, the invention has been illustrated in conjunction with a longitudinally extending modular overhead console assembly having storage and lighting accessory modules in an automotive vehicle. However, the assembly may extend laterally or transversely with respect to the longitude of a vehicle, and the following additional accessory modules can be provided without departing from the disclosure: modules for climate control devices such as vents and fans, audiovisual devices such as digital video disc devices and television screens, garage door openers, eyeglasses holders, tissue dispensers, global positioning systems, and the like. Furthermore, the invention has been disclosed in conjunction with an automotive vehicle; however other implementations are contemplated, such as commercial trucks, vans, boats, trains, motor homes, and the like. Indeed, the present invention is intended to embrace all forms, ramifications, modifications, variations, substitutions, and/or equivalents as fall within the spirit and broad scope of the following claims.

1. A modular overhead console assembly for mounting to a roof of a vehicle within a passenger compartment of the vehicle, said assembly comprising:
a pair of supports having surfaces adapted to be mounted substantially against the roof of the vehicle and further having oppositely disposed surfaces;
a plurality of cross-members spanning said pair of supports and having surfaces adapted to be mounted substantially against the roof of the vehicle and further having oppositely disposed surfaces, wherein at least one of said plurality of cross-members and said plurality of longitudinally extending supports is adapted to be secured to the roof of the vehicle;
a headliner positioned substantially against said oppositely disposed sides of said pair of supports and said plurality of cross-members;
a pair of rails at least partially mounted against at least a portion of said oppositely disposed side of said plurality of cross-members with said at least a portion of said headliner disposed therebetween, said pair of rails comprising:
a pair of module rails including rail bases at least partially mounted against at least a portion of said oppositely disposed side of said plurality of cross-members, said plurality of module rails including rail heads extending from said rail bases wherein tracks are defined between said rail heads and said rail bases; and
a pair of rail covers mounted to said pair of module rails; and
at least one movable module slidably mounted to said pair of module rails and interlockable therewith along at least a portion of the length thereof, said at least one movable module including a base having a portion thereof extending into said tracks.

2. The modular overhead console assembly of claim 1, wherein said pair of module rails is extruded and said pair of rail covers is rolled.

3. The modular overhead console assembly of claim 1, wherein said pair of rails has inboard sides and oppositely disposed outboard sides, further wherein said at least one movable module is mounted to said pair of rails substantially between said inboard sides.

4. The modular overhead console assembly of claim 1, wherein at least one of said pair of rails includes a series of longitudinally spaced apart engagement elements formed at its inboard side and extending along at least a portion of its length, further wherein said at least one movable module, includes a latch adapted for default engagement with said series of longitudinally spaced apart engagement elements.

5. The modular overhead console assembly of claim 4, wherein said pair of rail covers of said pair of rails includes said series of longitudinally spaced apart engagement elements.

6. The modular overhead console assembly of claim 1, wherein said pair of rails includes longitudinally opposed ends and said modular overhead console assembly further comprises at least one removable stationary module mounted to at least one of said longitudinally opposed ends of said pair of rails.

7. The modular overhead console assembly of claim 6, wherein said at least one removable stationary module is removable to permit said at least one movable module to be assembled to and removed from said pair of rails.

8. The modular overhead console assembly of claim 1, wherein said pair of rails includes at least one electrical conductor extending therealong and attached thereto.

9. The modular overhead console assembly of claim 8, wherein said pair of rails includes longitudinally opposed ends and said modular overhead console assembly further comprises at least one removable stationary module mounted to at least one of said longitudinally opposed ends of said pair of rails, and further wherein said at least one removable stationary module includes at least one electrical contactor mounted thereto and adaptable to be in contact with said at least one electrical conductor of said pair of rails when said at least one removable stationary module is mounted to said pair of rails.

10. The modular overhead console assembly of claim 8, wherein said at least one movable module includes at least one electrical contactor mounted thereto and adaptable to be in contact with said at least one electrical conductor of said plurality of module rails when said at least one movable module is mounted to said plurality of module rails.

11. The modular overhead console assembly of claim 8, wherein said at least one electrical conductor comprises a flexible circuit.

12. The modular overhead console assembly of claim 1, wherein said pair of rails includes at least one light pipe extending therealong and attached thereto.

13. The modular overhead console assembly of claim 1, wherein said at least one movable module includes a latch adapted for default engagement with a portion of at least one of said pair of rails and for selective disengagement from said portion of said at least one of said pair of rails.

14. The modular overhead console assembly of claim 13, wherein said latch is spring biased into said default engagement.

15. A modular overhead console assembly adapted to be mounted to a roof of a vehicle, said modular overhead console assembly comprising:
a plurality of cross-members having oppositely disposed ends and further having sides adapted to be mounted against the roof of the vehicle and also having oppositely disposed surfaces;
a plurality of rails at least partially mounted against at least a portion of said oppositely disposed surfaces of said plurality of cross-members, said plurality of rails including rail bases mounted against at least a portion of said oppositely disposed surfaces of said plurality of cross-members at said oppositely disposed ends thereof such that said plurality of cross-members extend substantially laterally between and at least partially overlap said plurality of rails, said plurality of rails including rail heads extending from said rail bases wherein tracks are defined between said rail heads and said rail bases; and
at least one movable module slidably mounted to said plurality of rails and interlockable therewith along at least a portion of the length thereof, said at least one movable module including a base having a portion thereof extending into said tracks.

16. The modular overhead console assembly of claim 15, wherein said plurality of rails comprises a plurality of extruded module rails and a plurality of rolled rail covers attached to said plurality of extruded module rails.

17. The modular overhead console assembly of claim 15, wherein said plurality of rails has inboard sides and oppositely disposed outboard sides, further wherein said at least one movable module is mounted to said plurality of rails substantially between said inboard sides.

18. The modular overhead console assembly of claim 15, wherein at least one of said plurality of rails includes a series of longitudinally spaced apart engagement elements formed at its inboard side and extending along at least a portion of its length, further wherein said at least one movable module includes a latch adapted for engagement with said series of longitudinally spaced apart engagement elements.

19. The modular overhead console assembly of claim 18, wherein said plurality of rails comprises a plurality of module rails and a plurality of rail covers attached to said plurality of module rails, further wherein said plurality of rail covers of said plurality of rails includes said series of longitudinally spaced apart engagement elements.

20. The modular overhead console assembly of claim 15, wherein said plurality of rails includes longitudinally opposed ends and said modular overhead console assembly further comprises at least one removable stationary module mounted to at least one of said longitudinally opposed ends of said plurality of rails.

21. The modular overhead console assembly of claim 20, wherein said at least one removable stationary module is removable to permit said at least one movable module to be assembled to and removed from said plurality of rails.

22. The modular overhead console assembly of claim 15, wherein said plurality of rails includes at least one electrical conductor extending therealong and attached thereto.

23. The modular overhead console assembly of claim 22, wherein said plurality of rails includes longitudinally opposed ends and said modular overhead console assembly further comprises at least one removable stationary module mounted to at least one of said longitudinally opposed ends of said plurality of rails, and further wherein said at least one removable stationary module includes at least one electrical contactor mounted thereto and adaptable to be in contact with said at least one electrical conductor of said plurality of rails when said at least one removable stationary module is mounted to said plurality of rails.

24. The modular overhead console assembly of claim 22, wherein said at least one movable module includes at least one electrical contactor mounted thereto and adaptable to be in contact with said at least one electrical conductor of said plurality of rails when said at least one movable module is mounted to said plurality of rails.

25. The modular overhead console assembly of claim 22, wherein said at least one electrical conductor comprises a flexible circuit.

26. The modular overhead console assembly of claim 15, wherein said pair of rails includes at least one light pipe extending therealong.

27. The modular overhead console assembly of claim 15, wherein said at least one movable module includes a latch adapted for default engagement with a portion of at least one of said pair of rails and for selective disengagement from said portion of said at least one of said pair of rails.

28. The modular overhead console assembly of claim 27, wherein said latch is spring biased into said default engagement.

29. A modular overhead console assembly adapted to be mounted to a roof of a vehicle, said modular overhead console assembly comprising:
at least one rail including a rail base and a rail head extending from said rail base wherein a track is defined between said rail head and said rail base, said at least one rail including a series of longitudinally spaced apart engagement elements extending along at least a portion of its length; and
at least one movable module slidably mounted to said pair of module rails and interlockable therewith along at least a portion of the length thereof, said at least one movable module including a base having a portion thereof extending into said tracks.

30. The modular overhead console assembly of claim 29, wherein said at least one rail comprises at least one extruded module rail.

31. The modular overhead console assembly of claim 29, wherein said at least one movable module includes a latch adapted for engagement with said series of longitudinally spaced apart engagement elements of said at least one rail.

32. The modular overhead console assembly of claim 29, wherein said at least one rail comprises at least one module rails and at least one rail cover attached to said at least one module rail, further wherein said at least one rail cover of said at least one rail includes said series of longitudinally spaced apart engagement elements.

33. The modular overhead console assembly of claim 29, wherein said at least one rail includes longitudinally opposed ends and said modular overhead console assembly further comprises at least one removable stationary module mounted to at least one of said longitudinally opposed ends of said at least one rail.

34. The modular overhead console assembly of claim 33, wherein said at least one removable stationary module is removable to permit said at least one movable module to be assembled to and removed from said at least one rail.

35. The modular overhead console assembly of claim 29, wherein said at least one rail includes at least one electrical conductor extending therealong and attached thereto.

36. The modular overhead console assembly of claim 35, wherein said at least one rail includes longitudinally opposed ends and said modular overhead console assembly further comprises at least one removable stationary module mounted to at least one of said longitudinally opposed ends of said at least on rail, and further wherein said at least one removable stationary module includes at least one electrical contactor mounted thereto and adaptable to be in contact with said at least one electrical conductor of said at least one rail when said at least one removable stationary module is mounted to said at least one rail.

37. The modular overhead console assembly of claim 36, wherein said at least one movable module includes at least one electrical contactor mounted thereto and adaptable to be in contact with said at least one electrical conductor of said at least one rail when said at least one movable module is mounted to said at least one rail.

38. The modular overhead console assembly of claim 35, wherein said at least one electrical conductor comprises a flexible circuit.

39. The modular overhead console assembly of claim 29, wherein said pair of rails includes at least one light pipe extending therealong.

40. A module adapted for use with a modular overhead console assembly adapted to be mounted to a roof of a vehicle, said modular overhead console assembly including a plurality of rails including rail bases and rail heads extending from said rail bases wherein tracks are defined between said rail heads and said rail bases, said module comprising:
a housing;
a base supporting said housing, said base having a portion thereof extending into said tracks, wherein said module is slidably mounted to said plurality of rails and is adapted for default engagement with a portion of at least one of said pair of rails and for selective disengagement from said portion of said at least one of said pair of rails.
